(19) United States
(12) Patent Application Publication
(10) Pub. No.: US 2017/0217802 A1
(43) Pub. Date: Aug. 3, 2017

(54) METHOD FOR BARIUM AND NORM REMOVAL FROM PRODUCED WATER

(71) Applicant: GENERAL ELECTRIC COMPANY, Schenectady, NY (US)

(72) Inventors: William Leonard KOSTEDT, IV, Clifton Park, NY (US); Vicki Herzl WATKINS, Alplaus, NY (US); James Manio SILVA, Clifton Park, NY (US); Rachel Marie GETTINGS, Albany, NY (US); Peter Harold WREDE, Delmar, NY (US)

(21) Appl. No.: 15/124,228

(22) PCT Filed: Mar. 9, 2015
(86) PCT No.: PCT/US2015/019420

§ 371 Date: Sep. 7, 2016

Related U.S. Application Data
(60) Provisional application No. 61/949,364, filed on Mar. 7, 2014.

(51) Int. Cl. C02F 1/56; C02F 1/66; C01F 11/46; B01D 9/00; C01F 13/00; C02F 1/52; C02F 1/04

(52) U.S. Cl. CPC C02F 1/56; C02F 1/5236; C02F 1/66; C02F 1/048; B01D 9/0018; C01F 13/00; C01F 11/462; C02F 2001/007

(57) ABSTRACT

A method of removing barium and naturally occurring radioactive material from produced water. The method includes pretreating the produced water having a pH in a range of from about 4.0 to about 10.0 with a sulfate source to form a suspension of barium sulfate, radium sulfate, or a combination thereof, treating the pretreated produced water with an anionic flocculant and gravitational])′ separating the treated produced water from the barium sulfate, radium sulfate, or a combination thereof.

### CROSS-REFERENCE TO RELATED APPLICATIONS

This application is a national stage application under 35 U.S.C. §371(c) of prior filed, co-pending PCT application serial number PCT/US2015/019420, filed on Mar. 9, 2015 which claims priority to U.S. Provisional Application Ser. No. 61/949,364, titled “PRETREATMENT PROCESS FOR BARIUM AND NORM REMOVAL FROM PRODUCED WATER”, filed on Mar. 7, 2014. The above-listed applications are herein incorporated by reference.

### STATEMENT REGARDING FEDERALLY SPONSORED RESEARCH AND DEVELOPMENT

This invention was made with Government support under Subcontract 10122-07 to Research Partnership to Secure Energy for America (RPSEA), a contractor to the United States Department of Energy under prime contract DE-AC-07NT42677. The Government has certain rights in the invention.

### FIELD OF THE INVENTION

Embodiments of the invention relate generally to a process for treating water, and more particularly, to a process for removing barium and naturally occurring radioactive materials (NORM), such as radium, from produced water.

### BACKGROUND OF THE INVENTION

The contribution to the US energy supply from unconventional gas sources, such as shale gas production, is growing dramatically. Water is used extensively in shale gas production in the drilling and hydrofracturing processes and therefore, water management is a key concern. Mining, drilling, and hydrofracturing each require consideration of post-process water treatment. For example, hydrofracturing creates produced water, which may contain significant levels of Naturally Occurring Radioactive Materials (“NORM”), including radium, in conjunction with very high salinity levels and high levels of hardness ions, including magnesium, calcium, strontium, and barium. In addition, iron and manganese are often present. Soluble barium is toxic and can precipitate causing scaling formation on processing equipment. Radium is carcinogenic.

Some produced water may be disposed by deep-well injection. However, in certain locations, including Pennsylvania, the ability to dispose of produced water by deep-well injection may be limited. Therefore, in at least these locations, an economical process is necessary to treat the produced water, to permit other uses and/or disposal.

Previous attempts have utilized sulfate precipitation to treat produced water and remove radioactive materials and barium, allowing the water to be later re-used or disposed. In such a process, bulk solids and sulfate precipitates are generated and separated from the water. Sulfate precipitation is an effective treatment for high salinity water, but it forms a very fine particle dispersion (particle sizes are less than 100 micrometers), which is difficult to separate from the water. The particle settling rate is too slow to allow for gravitational separation.

Filtration, such as a press filter, can be used to help separate the sulfate precipitate from the water, but filters are expensive and not altogether effective due to the small particle size of the dispersion.

As such, there is a need for a process that utilizes sulfate precipitation but also provides a fast and cost-effective process for removing NORM and barium from produced water. Furthermore, there is a need for a process that generates a solid salt product to achieve higher water recovery.

### BRIEF DESCRIPTION OF THE INVENTION

In one embodiment, there is a method of removing barium and naturally occurring radioactive material from produced water. The method includes pretreating the produced water having a pH in a range of from about 4.0 to about 10.0 with a sulfate source to form a suspension of barium sulfate, radium sulfate, or a combination thereof, treating the pretreated produced water with an anionic flocculant and gravitationally separating the treated produced water from the barium sulfate, radium sulfate, or a combination thereof.

In another embodiment, there is a method of producing a recovered salt product from produced water. The method includes removing barium and naturally occurring radioactive materials from produced water, evaporating the separated water to form distilled water and a concentrated brine, crystallizing salt crystals from the concentrated brine, and washing the salt crystals to produce recovered salt product. The removing barium and naturally occurring radioactive materials from produced water includes: pretreating the produced water having a pH in a range of from about 4.0 to about 10.0 with a sulfate source to form a suspension of barium sulfate, radium sulfate, or a combination thereof, treating the pretreated produced water with an anionic flocculant; and gravitationally separating the treated produced water from the barium sulfate, radium sulfate, or a combination thereof.

In another embodiment, there is a system for producing a recovered salt product with a low concentration of barium and NORM from produced water. The system includes: a barium and NORM treatment apparatus; a gravitational separation unit; an evaporation unit that produces distilled water and a concentrated brine from the separated water; a crystallization unit configured to produce salt crystals from the concentrated brine; and a crystal treatment unit configured to wash the salt crystals to produce the recovered salt product. The barium and NORM treatment apparatus configured to pretreat the produced water having a pH in a range of from about 4.0 to about 10.0 with a sulfate source to form a suspension of barium sulfate, radium sulfate, or a combination thereof; and treat the pretreated produced water with an anionic flocculant. The gravitational separation unit is configured to separate the treated water from the barium sulfate, radium sulfate, or a combination thereof.

The various embodiments provide quick and economical methods for treating produced water to remove barium and NORM, such as radium. In other embodiments, salt products and distilled water having low levels of barium and NORM are produced.

### BRIEF DESCRIPTION OF THE DRAWINGS

Additional features, possibilities of use, and advantages of the invention can be inferred from the description of the embodiments of the invention hereinafter. In doing so, the object of the invention is represented by each of the described or illustrated examples, individually or in any combination, and independently of their summarization or their citation or illustration in the description, or in the figures. In the drawings:

FIG. 1 is a schematic flow chart of a barium and NORM removal process in accordance with an embodiment of the invention;

FIG. 2 is a schematic flow chart of a process for the production of a recovered salt product with a low concentration of barium and naturally occurring radioactive materials from produced water in accordance with an embodiment of the invention; and

FIG. 3 is a schematic diagram depicting an exemplary embodiment of a system for producing a recovered salt product.

### DETAILED DESCRIPTION OF THE INVENTION

The singular forms “a,” “an” and “the” include plural referents unless the context clearly dictates otherwise. The endpoints of all ranges reciting the same characteristic are independently combinable and inclusive of the recited endpoint.

Any numerical values recited herein include all values from the lower value to the upper value in increments of one unit provided that there is a separation of at least 2 units between any lower value and any higher value. As an example, if it is stated that the amount of a component or a value of a process variable such as, for example, temperature, pressure, time and the like is, for example, from 1 to 90, it is intended that values such as 15 to 85, 22 to 68, 43 to 51, 30 to 32, etc. are expressly enumerated in this specification. For values which are less than one, one unit is considered to be 0.0001, 0.001, 0.01 or 0.1 as appropriate. These are only examples of what is specifically intended and all possible combinations of numerical values between the lowest value and the highest value enumerated are to be considered to be expressly stated in this application in a similar manner.

The modifier “about” used in connection with a quantity is inclusive of the stated value and has the meaning dictated by the context (e.g., includes the tolerance ranges associated with measurement of the particular quantity).

An aspect of the invention is a method of removing barium and NORM from produced water. The method includes: pretreating the produced water having a pH in a range of from about 4.0 to about 10.0 with a sulfate source to form a suspension of barium sulfate, radium sulfate, or a combination thereof; treating the pretreated produced water with an anionic flocculant; and gravitationally separating the treated produced water from the barium sulfate, radium sulfate, or a combination thereof.

Produced water, as used herein, shall mean water that is a by-product of mining, drilling, hydrofracturing or other resource-extracting processes, and includes hydraulic fracture flowback water, well completion water, formation water, and “frac water”. It should be understood, however, that the water treatment process may be utilized on any liquid sample if it is desirable to remove barium or NORM, such as radium, from the sample. Produced waters often have very high salinity and may contain high levels of barium or NORM, such as radium. For example, some produced waters include more than 200 mg/L of barium. In another example, produced water contains 1000 mg/L or more of barium. In another example, produced water contains 2000 mg/L or more of barium. In another example, barium may be present in produced water in a range of about 300 mg/L to about 30,000 mg/L or more. Produced waters can include more than 500 pCi/L of radium. In one example, radium may be present in produced water in a range of from about 500 pCi/L to about 18,000 pCi/L or more. Produced waters may have total dissolved solids in excess of 20,000 mg/L. In an embodiment of the invention, produced water contains greater than 70,000 mg/L total dissolved solids (TDS). In another example, produced water contains total dissolved solids in an amount of from about 20,000 mg/L to about 400,000 mg/L or more. In another example, produced water contains total dissolved solids in an amount of from about 50,000 to about 300,000 mg/L TDS or more. In the produced waters of interest, the majority of ions are typically sodium and chloride.

An example of contaminants found in produced water is shown in Table 1, which shows the analysis of several types of contaminants found in Marcellus shale gas produced water. Nine produced water samples from the Pennsylvania Marcellus shale gas site were analyzed. Table 1 provides a list of contaminants, the high and low end of the ranges found in the samples and median value.

TABLE 1
Marcellus Produced Water Compositions

| | 2013 Marcellus Survey (9 samples) | | |
|---|---|---|---|
| | (mg/L except where noted) | | |
| Component | Minimum | Maximum | Median |
| Na | 31,100 | 64,400 | 51,900 |
| Mg | 1,010 | 2,550 | 1,860 |
| Ca | 11,100 | 34,700 | 25,500 |
| Sr | 2,630 | 11,500 | 6,120 |
| Ba | 300 | 28,800 | 8,200 |
| Mn | 3 | 24 | 10 |
| Fe | 42 | 165 | 120 |
| Cl | 77,900 | 179,000 | 147,000 |
| TDS | 124,100 | 323,800 | 242,300 |
| ²²⁶Ra, pCi/L | 2,730 | 17,800 | 12,500 |

In an embodiment, the method comprises adjusting the pH of the produced water, if needed or if desired to adjust the water to a specific pH or range. The pH is adjusted by any conventional method known in the art, such as with the addition of at least one acid and/or base. In one embodiment, the pH may be adjusted with the addition of lime, sodium hydroxide, potassium hydroxide, ammonium hydroxide, hydrochloric acid, sulfuric acid, nitric acid, soda ash, sodium bicarbonate, carbon dioxide or any combination thereof. In an embodiment of the invention, adjusting the pH is accomplished by the addition of lime, sodium hydroxide, or a combination thereof.

Embodiments of the current invention provide for the efficient removal of barium and radium through the use of a sulfate treatment over a wide pH range. For example, the water pretreated with a sulfate source can have a pH in a range of about 4.0 to about 10.0. In another embodiment, the pH is in a range of from about 5.0 to about 10.0. Alternatively, the pH can be in a range of about 5.0 to about 9.0, about 5.0 to about 9.5, about 7.0 to about 10.0, about 8.0 to about 10.0, about 7.0 to about 9.5, about 9.0 to about 9.5, or about 9.0 to about 10.0. In an embodiment, the sulfate pretreatment is performed at a pH of 9.0, which is particularly effective at removing barium and radium from produced water. In contrast, an excessively high pH, for example 11.0, makes the anionic flocculant less effective at producing a floc, while increasing the bulk waste stream.

The pH of the produced water may be adjusted prior to sulfate precipitation or may be adjusted simultaneously with the sulfate precipitation. In another embodiment, the pH may be further adjusted following sulfate precipitation. The kinetics of oxidation are faster at the higher pH, such that a smaller vessel and/or residence time is required for the oxidation of metal ions, for example Fe²⁺ and Mn²⁺, as discussed in greater detail below.

The sulfate source may be any type of compound that provides sulfate ions to the produced water and is suitable for reacting with the barium and NORM present in the produced water. In an embodiment, the sulfate source does not introduce additional elements that require hazardous material disposal or additional removal techniques. In an embodiment, the sulfate source is sodium sulfate, potassium sulfate, magnesium sulfate, calcium sulfate, strontium sulfate, or a combination thereof. In another embodiment, the sulfate source is sodium sulfate because it is an inexpensive sulfate source, which does not contain elements that require hazardous material disposal. Although magnesium sulfate, calcium sulfate, and strontium sulfate can be the sulfate source, they possess a lower solubility than sodium sulfate and are thus, less effective in the removal of barium and radium.

The sulfate source can be added in any amount (dose) effective for precipitating the barium or NORM from the produced water. The amount of sulfate source added can be based on a molar ratio of sulfate to barium dissolved in the produced water. In some embodiments, a sulfate source is added to achieve a sulfate to barium ratio of about 0.90 to about 1.20. In another embodiment, the sulfate to barium ratio is from about 1.00 to about 1.15. In another embodiment, the sulfate to barium ratio is from about 1.10 to about 1.13.

The addition of a sulfate source to produced water results in the precipitation of barium and radium as barium sulfate and radium sulfate, respectively. Precipitation of calcium and strontium can also occur as calcium sulfate and strontium sulfate, respectively, depending on the process conditions, the produced water composition, and the molar ratio of sulfate to barium. In some embodiments, pretreating the produced water with a sulfate source includes at least one of: (1) adding the sulfate source incrementally to the produced water, (2) adding the sulfate source in a single batch to the produced water, and (3) agitating or stirring the produced water during and/or after the addition of the sulfate source and before treating the pretreated water with the anionic flocculant.

Stirring or agitating the sulfate source with the produced water can occur for about 0.25 minutes to about 30 minutes. In another embodiment, stirring or agitation can occur from about 1 minute to about 15 minutes. In another embodiment, the mixture is agitated from about 3 minutes to about 10 minutes. In another embodiment, the mixture is agitated from about 5 minutes to about 10 minutes. In other embodiments, the mixture can be agitated for one of the following ranges: about 0.25 minutes to about 15 minutes, about 0.25 minutes to about 10 minutes, about 0.25 minutes to about 5 minutes, about 1 minute to about 30 minutes, about 1 minute to about 3 minutes, or about 1 minute to about 5 minutes.

In an embodiment, the anionic flocculant is a polyelectrolyte. The anionic flocculant is added in an amount (dose) sufficient to flocculate the sulfate precipitation from the pretreated water. For example, the resultant concentration of anionic flocculant in the treated water can be in a range of about 1.0 to about 150 mg/L. Alternatively, the anionic flocculant can be added such that it results in a concentration of anionic flocculant that falls within one of the following ranges: 1.25 mg/L to about 125 mg/L, about 1.25 mg/L to about 12.50 mg/L, about 6.25 mg/L to about 12.50 mg/L, about 6.25 mg/L to about 25.0 mg/L, about 1.25 mg/L to about 50.0 mg/L, about 1.25 mg/L to about 125.0 mg/L, or about 6.25 mg/L to about 50.0 mg/L.

The anionic flocculant has a molecular weight in a range of about 1 million to about 50 million Daltons. In one embodiment, the anionic flocculant has a high molecular weight, for example, in a range of from about 15 million Dalton to about 50 million Daltons. In another embodiment, the anionic flocculant has a low molecular weight in a range of from about 1 million Daltons to about 10 million Daltons. Alternatively, the molecular weight of the anionic flocculant can be in one of the following ranges: about 15 million to about 50 million Daltons, about 1 million to about 30 million Daltons, about 1 million to about 25 million Daltons, about 15 million to about 30 million Daltons, about 12 million to about 25 million Daltons, and about 15 million to about 25 million Daltons. In an embodiment, the anionic flocculant has a molecular weight of about 23 million Daltons.

After the addition of the anionic polyelectrolyte flocculant, the treated water may be agitated (or stirred) for a sufficient amount of time to effectively flocculate the precipitate formed in the pretreated water. In one embodiment, the treated water is stirred for about 1 to about 10 minutes. In another embodiment, the water is stirred for about 1 to about 5 minutes. In one embodiment, the agitation, stirring, or mixing intensity is gradually reduced (i.e., becomes more gentle) as floc forms to avoid breakage of the floc. In an embodiment, the agitation or stirring may be vigorous at first and incrementally or gradually decreased in intensity.

In an embodiment, the anionic flocculant has an anionicity of about 5% to about 50%. Alternatively, the anionicity of the anionic flocculant can be in a range of from about 5% to about 30% or from about 5% to about 15%. In another embodiment, the anionicity of the anionic flocculant is up to about 15%. In an additional embodiment, the anionic flocculant has an anionicity of less than 25%. In an embodiment, the anionic flocculant has a charge density of about 0.05 mEq/g to about 10.0 mEq/g. In an alternative embodiment, the anionic flocculant can have a charge density in a range of about 0.08 mEq/g to about 7.0 mEq/g.

In an embodiment, the anionic flocculant is a linear polymer. In an embodiment, the anionic flocculant includes anionic acrylamide copolymers. Anionic acrylamide copolymers can be copolymers of acrylamide and acrylic acid. The copolymers can be in a random arrangement with regard to charge and location. In an embodiment, the anionic flocculant has about 50 to about 95 mole percent acrylamide residue. Alternatively, the anionic flocculant has about 70 to about 90 mole percent or about 80 to about 90 mole percent acrylamide residue, of which the latter is a particularly effective flocculant. Examples of anionic polyelectrolyte flocculants are PolyFloc® AE1115, AE1125, AE1700, AE1701 and AE1702, all sold by GE-Betz. Of which, the AE1700 series (i.e. AE1700-1703) have extremely high molecular weights, that is, greater than 15 million Daltons. Flocculants AE1125 and 1125 have low molecular weights, that is, less than 15 million Daltons, and in particular, less than 11 million Daltons.

After the anionic flocculant is added, the treated water is gravitationally separated. Gravitational separation of the clarate and floc of the treated water can be performed by any conventional method known in the art. In one embodiment, gravitational separation may occur in a clarifier, gravity separator, settling tank, or centrifugal separator. Floc forms towards the top of the water and any sludge can be removed from the bottom of the treated water. The produced floc includes barium and radium from the produced water, which is precipitated as barium sulfate and radium sulfate.

The floc forms rapidly, allowing quick and easy removal of the flocculated precipitate from the water. In one embodiment, the floc settles in less than about 15 minutes. In another embodiment, the floc settles in less than about 10 minutes. In another embodiment, the floc settles in less than about 5 minutes. In another embodiment, the floc settles in less than about 3 minutes. In one embodiment, the precipitate settles out of solution in a range of from about 1 minute to about 15 minutes. In another embodiment, the range is from about 1 minute to about 10 minutes. In another embodiment, the range is from about 1 minute to about 5 minutes. In another embodiment, the range is from about 1 minute to about 3 minutes. In one embodiment, the precipitate settles in about 2 minutes and in another embodiment, the precipitate settles in about 1 minute. The resultant clarate has substantially reduced suspended solids.

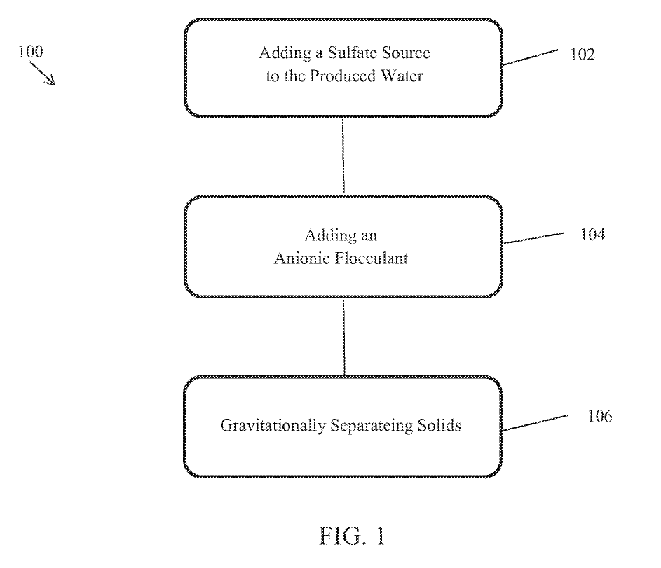

An embodiment of barium and NORM removal process 100 is shown in FIG. 1. The process 100 includes: adding a sulfate source to the produced water 102 having a pH in a range of from about 4.0 to about 10.0 to form a suspension of barium sulfate, radium sulfate, or a combination thereof; adding an anionic flocculant to the sulfate treated produced water 104; and gravitationally separating the treated water 106 from the barium sulfate, radium sulfate, or a combination thereof. As discussed above, the barium and NORM removal process can also include adjusting the pH of the water before or after sulfate treatment. The barium and NORM removal process can also include aerating the water before or after sulfate treatment and removing the metal-hydroxide sludge separate from the barium/NORM sludge (not shown in FIG. 1), which will be discussed below. In an embodiment, the barium concentration of the gravitationally separated water leaving the process for removing barium and/or NORM form produced water is less than 200 mg Ba/liter, which results in the recovered salt product, such as sodium chloride, containing less than 5 mg/L barium. In some embodiments, the gravitationally separated water leaving the pretreatment process is also pH neutral.

Additional pretreatment and treatment steps may be utilized to prepare the produced water for re-use or disposal. In one embodiment, bulk solids in the water may be separated and removed from the water, such as in an equalization basin. Bulk solids may be separated prior to pretreating the produced water, between the steps of pretreating and treating, or during the gravitational separation of the treated water.

In another embodiment, iron and manganese can be removed from produced water. Iron and manganese may be present in produced water. In one embodiment, manganese can be present in amounts greater than 1 mg/L. In another embodiment, manganese may be present from about 1 mg/L to 50 mg/L or greater. Iron may be present in amounts greater than 10 mg/L. In another embodiment, iron may be present from about 10 mg/L to about 200 mg/L or greater.

To remove iron, magnesium, calcium, manganese, or any combination thereof, the pH of the water is adjusted with a base or acid to achieve a pH in the range of about 9.0 to about 10.0, if needed. pH adjustment is described above. Adjusting the pH of produced water to about 9.0 to about 10.0, and in particular about 9.0 to about 9.5, results in the production of a metal-hydroxide sludge. The metal-hydroxide sludge can include suspended solids, organics, iron, manganese, or a combination thereof. In particular, iron and manganese precipitate as ferric iron solid (Fe(OH)₃) and manganese dioxide (MnO₂), respectively. Magnesium precipitates as magnesium hydroxide. The precipitation of metal-hydroxides can be performed before, along with, or after pretreating the produced water with a sulfate source. That is, adding a sulfate source occurs before adding a base, simultaneously with adding a base, or after adding a base.

In an embodiment, the method further includes separating the metal-hydroxide sludge produced from adjusting the pH to about 9.0 to about 10.0 or about 9.0 to about 9.5 from the water prior to pretreatment with the sulfate source. This allows for the disposal of the metal-hydroxide sludge prior to the addition of the sulfate source. In this embodiment, sulfate containing sludge is created subsequent to the separation of the metal-hydroxide sludge. This allows for the metal-hydroxide sludge and sulfate containing sludge to be treated separately.

Alternatively, the iron, manganese, and magnesium can be precipitated after pretreating the produced water with a sulfate source. That is, adding a sulfate source and the separation of its sulfate containing sludge is performed prior to adding an acid or base source and the separation of the resultant metal-hydroxide sludge. This too allows for disposal of each sludge without the need to accommodate the later-created sludge. The metal-hydroxide sludge and the sulfate containing sludge can each be disposed of according to its particular waste stream requirements when handled separately. Furthermore, separately handling each sludge prevents contamination and accumulation of waste in a sludge that could otherwise be disposed of more easily or efficiently elsewhere.

In an embodiment, the order of addition of a sulfate source and an acid or base for pH adjustment, as well as when to separate the produced sludge, is dependent on:
(a) the ratio of dry TSS (total suspended solids) in the produced water (mg/L) to the concentration of barium in the produced water (mg/L), where <0.1 is a low ratio and ≧0.1 is a high ratio;
(b) the radium activity in the dry suspended solids, where <1,400 pCi/gm is low activity and >1,400 pCi/gm is high activity; and
(c) the ratio of radium activity (pCi/L) to the barium concentration (mg/L) in the produced water, where <0.85 pCi Ra/mg Ba²⁺ is a low ratio and ≧0.85 pCi Ra/mg Ba²⁺ is a high ratio.

In this embodiment, these parameters are utilized to determine the order of the addition of a sulfate source, as well as a base and sludge processing, for example, as shown in Table 2.

TABLE 2

| | Dry TSS | Ratio of ²²⁶Ra | |
|---|---|---|---|
| Ratio of | ²²⁶Ra | Activity | |
| TSS/Ba²⁺ | Activity | to Ba²⁺ | Example Order of Processes |
| Low | Low | Low | 1. Sulfate¹, base², sludge |
| | | | removal³ |
| | | | 2. Base², sulfate¹, sludge |
| | | | removal³ |
| Low | Low | High | 1. Sulfate¹, base², sludge |
| | | | removal³ |
| | | | 2. Base², sulfate¹, sludge |
| | | | removal³ |
| Low | High | Low | 1. Base, sludge removal, sulfate, |
| | | | sludge removal |
| | | | 2. Sulfate, base, sludge removal |
| | | | 3. Base, sulfate, sludge removal |
| Low | High | High | 1. Sulfate¹, base², sludge |
| | | | removal³ |
| | | | 2. Base², sulfate¹, sludge |
| | | | removal³ |
| High | Low | Low | 1. Sulfate¹, base², sludge |
| | | | removal³ |
| | | | 2. Base², sulfate¹, sludge |
| | | | removal³ |
| High | Low | High | 1. Base², sludge removal³, |
| | | | sulfate¹, sludge removal³ |
| High | High | Low | 1. Base², sludge removal³, |
| | | | sulfate¹, sludge removal³ |
| High | High | High | 1. Sulfate¹, base², sludge |
| | | | removal³ |
| | | | 2. Base², sulfate¹, sludge |
| | | | removal³ |

¹Treating the produced water with a sulfate source.
²Adjusting the pH of the produced water to a range of about 9.0 to about 10.0 or about 9.0 to about 9.5.
³Separating clarate and sludge.

For example, and with reference to Table 2, when all three parameters are low or high, the addition of a base source and a sulfate source may occur in any order or simultaneously, and the produced sludge can be separated after the addition of both sources. By way of another example, when the radium-226 activity in the dry suspended solids is high, while the two ratios are low, the addition of base and sulfate may occur in any order or simultaneously, and separating the produced sludge is performed after the base and sulfate sources have been added, or separating the iron-manganese sludge after adding the base, which is followed by adding the sulfate source and separate the barium sulfate and/or radium sulfate containing sludge.

In another embodiment, the method further comprises aerating the produced water after adjusting the pH to about 9.0 to about 9.5. Aeration assists with the oxidation of dissolved iron, manganese, and magnesium in the produced water. Aeration can be accomplished using house air and should occur for a period of time sufficient to oxidize the iron and manganese present in the pH produced water. It is believed that CO₂ in the house air assists in the precipitation of Ca⁺² ions as CaCO₃. In an embodiment, aeration is applied for about 60 minutes. In another embodiment, aeration may occur in a range of from about 30 minutes to about 120 minutes.

In an embodiment, aerating the produced water is performed prior to adding the sulfate source to the produced water. Aerating can occur after separating the bulk solids from the produced water, but prior to separating the sulfate precipitates from the produced water. Alternatively, the aeration can occur prior to separating either bulk solids or the sulfate precipitation step. In another embodiment, the aeration occurs after separating any bulk solids and the sulfate precipitation step.

In an embodiment, the method further comprises adding a coagulant. The coagulant can be any conventional coagulant known in the art. Some examples of coagulants that may be used include ferric chloride, ferric sulfate, polyaluminum chloride, polyamines, polydiallyldimethylammonium chloride (polyDADMAC), tannins, aluminum sulfate, ferrous sulfate, or combinations thereof. In an embodiment, the coagulant includes a blend of polyaluminum chloride, polyamines, and acrylamide. The coagulant is added in amounts effective to enhance floc formation. In one embodiment, the coagulant may be added in an amount of from about 0.1 mg/L to about 100 mg/L. In another embodiment, the coagulant may be added in an amount of from about 1 mg/L to about 50 mg/L. In another embodiment, the coagulant may be added in an amount of from about 10 mg/L to about 30 mg/L. The coagulant can be added along with the anionic flocculant or after the anionic flocculant is added. In an embodiment, a coagulant is added when treating with the sulfate source and anionic flocculant alone results in a cloudy clarate, for example, the clarate has greater than 20 mg/L TSS, greater than 40 mg/L TSS, or greater than 100 mg/L TSS. In another embodiment, a coagulant can be added when a low molecular weight anionic flocculant is used, for example less than 15 million Daltons, and in particular, less than 11 million Daltons.

Another aspect of the invention is a method of producing a recovered salt product with a low concentration of barium and naturally occurring radioactive materials from produced water. The method includes: removing barium and naturally occurring radioactive materials from the produced water, evaporating the separated water to form distilled water and a concentrated brine; crystallizing salt crystals, for example sodium chloride, from the concentrated brine; and washing the salt crystals to produce the recovered salt product. Removing barium and naturally occurring radioactive materials includes: pretreating the produced water having a pH in a range of from about 4.0 to about 10.0 with a sulfate source to form a suspension of barium sulfate, radium sulfate, or a combination thereof; treating the pretreated produced water with an anionic polyelectrolyte flocculant; and gravitationally separating the treated produced water from the barium sulfate, radium sulfate, or a combination thereof.

In an embodiment, the separated produced water has a barium concentration of 200 mg/L or less. By having a barium concentration of 200 mg/L or less in the separated water, the recovered salt product contains less than 5 mg/L barium. The recovered salt product is the salt recovered from the overall process, which includes removing barium and radium, evaporating, crystallizing, and washing the salt crystal. In an embodiment, the separated produced water has a barium concentration of 100 mg/L or less, which provides a safety margin with respect to barium and radium levels within the recovered salt product. When the barium concentration in the separated produced water is 100 mg/L or less, the recovered salt product has an estimated radium activity of about 0.002 pCi/gm, which is an order of magnitude lower than typical values for rock salt. In another embodiment, the separated produced water has a radium concentration of 80 pCi/L or less, such that the recovered salt product has an estimated radium activity of about 0.002 pCi/gm.

Evaporating the separated water can be performed according to any conventional method known in the art. For example, a vessel comprising a motor configured to drive a paddle can be utilized and a bottom drain for the removal of a slurry of crystals. Evaporating can take place, for example, at atmospheric pressure until the weight fraction solids is, for example, twice that of the separated water.

In an embodiment, the extent of evaporation and amount of distilled water evaporated is dependent on several factors, including how much the sample is concentrated, expressed as a mass concentration factor. The mass concentration factor may be calculated as shown in equation (1):

$$Mass Concentration Factor = \frac{Pretreated Mass Rate ( lb \text{/} hr )}{Purge Mass Rate ( lb \text{/} hr )} . \qquad ( 1 )$$

Two mass concentration factors may be calculated, as shown in equations (2) and (3):

y₁=−0.00001446x+2.046 (2)

y₂=−2.3591n(x)+25.846 (3)

wherein x is the feed barium concentration (mg/L) and y is the mass concentration factor.

Evaporation should be controlled such that the final mass yields a mass concentration factory that is above the first calculated concentration (y₁) and below the second concentration factor (y₂). That is, in some embodiments, the concentration factor is between y₁ and y₂, the mass concentration factor of equations (2) and (3), respectively. Controlling evaporation in this manner prevents co-crystallization of barium chloride and sodium chloride, allowing sodium chloride crystals to be free from barium chloride solids and able to be removed by simple treatment processes. The calculated concentration factor of equations (2) and (3) converge when the feed barium concentration is about 27,000 mg/L, above which avoiding co-crystallization becomes difficult. As such, in an embodiment, the feed barium concentration is <27,000 mg/L.

Crystallizing results in the production of salt crystals, which includes, for example, sodium chloride. Crystallizing can be performed by any conventional means known in the art, and at any temperature conventional in the art. For example, crystallizing the concentrated brine can be performed in a range of about 106° C. to about 114° C. In an embodiment, evaporating and crystallizing is performed in an evaporator-crystallizer in a batch mode.

In an embodiment, the salt crystals can be dewatered by vacuum filtration, which can be performed by conventional means known in the art. For example, a 1 μm filter can be used during vacuum filtration. In an embodiment, the 1 μm filter is a glass fiber filter. In another embodiment, the dewatered crystals can be vacuum dried by any conventional means known in the art. For example, the dewatered crystals can be vacuum dried overnight at 95° C. In another embodiment, the dewatered crystals are further treated to remove entrained mother liquor from the crystal surface by any conventional means known in the art, for example washing, to minimize barium and other impurities in the salt crystals.

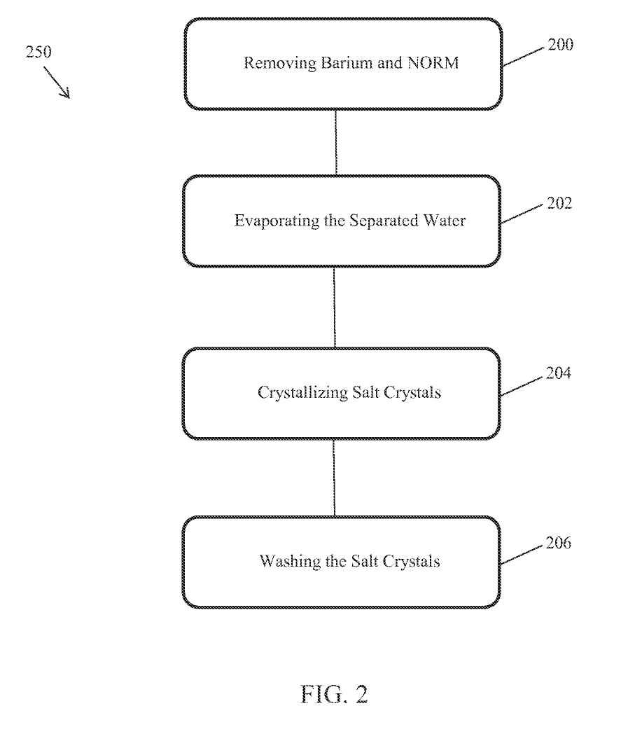

An embodiment of this method is shown in FIG. 2, referred to generally as 250. The method 250 includes: removing barium and NORM from produced water 100, 200, as described in FIG. 1; evaporating the separated water 202; crystallizing salt crystals 204; and washing the salt crystals 206. The method 250 results in the production of a recovered salt product, for example sodium chloride. Evaporating the separated water produces distilled water and a concentrated brine, which is crystallized and treated to form the recovered salt product. The washing of the salt crystals can include dewatering and drying, with crystallizer concentrate removed in the dewatering step as a system purge.

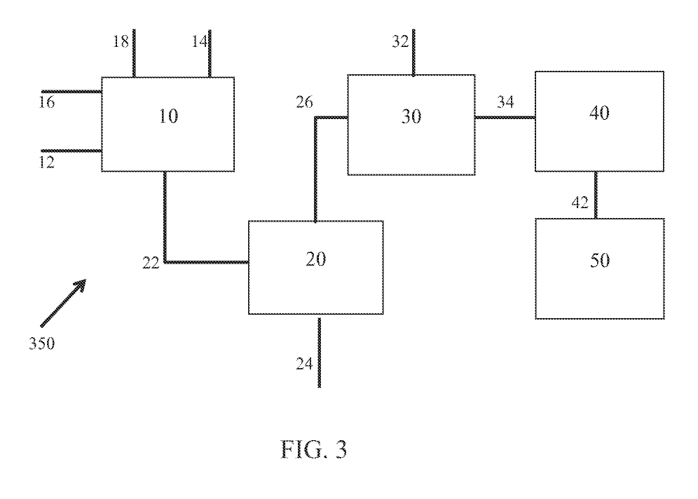

FIG. 3 illustrates a system 350 that can implement the process of producing a recovered salt product with a low concentration of barium and NORM from produced water 250 in accordance with an embodiment of the invention. The system 350 includes: a barium and NORM treatment apparatus 10; a gravitational separation unit 20; an evaporation unit 30; a crystallization unit 40, and a crystal treatment unit 50. It should be understood, however, that the evaporation unit 30 and crystallization unit 40 can be a single unit that performs the function of both units.

The barium and NORM treatment apparatus includes a produced water supply line 12 to supply produced water, a sulfate source supply line 14 to supply a sulfate source to the apparatus, an anionic flocculant supply line 16 to supply the anionic flocculant, and an acid and/or base supply line 18 to supply an acid and/or base to adjust the pH of the water, as discussed above. It should be appreciated that some of the supply lines could be combined as a single supply line, for example the sulfate source supply line 14 and the anionic flocculant supply line 16 as, for example, a treatment supply line (not shown). The slurry produced in the barium and NORM treatment apparatus is separated by the separating unit 20 by way of line 22. Here, the gravitational separation unit 20 separates a clarate, that is, the separated water, from a sludge, which is removed by way of a sludge line 24. The clarate from the gravitational separation unit 20 is sent to the evaporation unit 30 by way of line 26. Distilled water is removed from the evaporation unit 30 through line 32, while the produced concentrated brine is sent to the crystallization unit 40 by way of line 34. The crystallization unit 40 crystallizes the concentrated brine to produce salt crystals, which are transferred to the crystal treatment unit 50 through line 42. The salt crystals are further treated and/or washed, as discussed above, to produce the recovered salt product.

As discussed above, in an embodiment, the barium and NORM treatment apparatus can include adjusting the pH and/or aeration (not shown in FIG. 3) to produce a metal-hydroxide sludge. The addition of the pH changing substances and aeration can occur before, after, or at the same time as adding the sulfate source to the produced water. Furthermore, an additional separation step can be included (not shown in FIG. 3), such that the metal-hydroxide sludge and sulfate precipitation sludge are removed separately, thereby allowing for sludge to be treated separately.

In order that those skilled in the art will be better able to practice the present disclosure, the following examples are given by way of illustration and not by way of limitation.

### EXAMPLES

### Examples 1-6 and Comparative Examples 1-5

Produced water was (1130 gm) added to a 2-liter Erlenmeyer flask and amended with 6.2 g/L Ba as BaCl₂.2H₂O. The pH was adjusted to 9.0 with NaOH and aerated with air for 60 minutes via a sparger. Next, 1.1 mole Na₂SO₄, as 180 mL of 2.8M NaSO4, per mole of barium in the produced water was added and stirred for 15 minutes, and 20 mL of the mixture was aliquoted to each 20 mL vial. Flocculant was added to each vial as a 0.5 vol % solution to achieve a concentration of 1.25 mg/L, 12.5 mg/L, or 125 mg/L. The flocculants are identified by their GE-Betz product number, e.g. AE1700. Each vial was agitated at 200 RPM (rotations per minute) for 2 minutes, 60 RPM for 2 minutes, and then, gravitationally separated for 2 minutes. The clarate total suspended solids levels were measured via a Hach DR 3900 instrument. Table 3 demonstrates that the anionic flocculants (i.e., AE1115, AE1125, AE1700, AE1701, AE1702, and AE1703) performed orders of magnitude better than no flocculant, as shown by the comparative example CE-1, and the cationic flocculants of comparative samples CE-2 through CE-5 (i.e. PolyFloc® CP1154, CP1156, CP1158, and CP1160; each cationic flocculants is available from GE-Betz), as indicated by the measured suspended solids remaining in the clarate after the 2 minute settling period.

TABLE 3

| | | | | |
|---|---|---|---|---|
| Example | Flocculant | 1.25 mg/L | 12.5 mg/L | 125 mg/L |

No Flocculant

| | | | | |
|---|---|---|---|---|
| CE-1 | None | >1000 | >1000 | >1000 |

Anionic Flocculants

| | | | | |
|---|---|---|---|---|
| 1 | AE1115 | 38 | 19 | 45 |
| 2 | AE1125 | Cloudy | Clear | Slightly cloudy |
| 3 | AE1700 | 46 | 8 | 57 |
| 4 | AE1701 | 8 | 5 | 46 |
| 5 | AE1702 | 2 | 5 | 59 |
| 6 | AE1703 | 15 | 13 | 55 |

Cationic Flocculants

| | | | | |
|---|---|---|---|---|
| CE-2 | CP1154 | 495 | 338 | 804 |
| CE-3 | CP1156 | 551 | 132 | >1000 |
| CE-4 | CP1158 | 666 | 513 | 612 |
| CE-5 | CP1160 | 301 | 148 | 562 |

### Examples 7-12 and Comparative Example 6

Examples 7-12 and Comparative Example 6 was performed under the same protocol as Examples 1-6 and Comparative Examples 1-5, except that the pH was adjusted to 4.0 and the total suspended solids levels were determined by visual inspection. The visual inspection scale ranges from the clearest clarate, which is denoted by a 4, to the cloudiest clarate, which is denoted by a 1. As shown in Table 4, the anionic flocculants performed well at pH 4.0, see Examples 7-12, as compared to the cationic flocculant comparative example 6 (CE-6). That is, the majority of the anionic flocculants were able to achieve a 3 or 4 on visual inspection with a concentration of 1.25 mg/L or 12.5 mg/L, as compared to CE-6, which never achieved a visual inspection score above the cloudiest classification of 1 for all three concentrations tested.

TABLE 4

| | | | | |
|---|---|---|---|---|
| Example | Flocculant | 1.25 mg/L | 12.5 mg/L | 125 mg/L |

Anionic Flocculants

| | | | | |
|---|---|---|---|---|
| 7 | AE1115 | 3 | 2 | 1 |
| 8 | AE1125 | 3 | 4 | 1 |
| 9 | AE1700 | 4 | 3 | 1 |
| 10 | AE1701 | 3 | 4 | 1 |
| 11 | AE1702 | 2 | 3 | 1 |
| 12 | AE1703 | 1 | 3 | 2 |

Cationic Flocculants

| | | | | |
|---|---|---|---|---|
| CE-6 | CE1169 | 1 | 1 | 1 |

### Examples 13-15

The 2-Liter jar test was performed to further assess anionic flocculants AE1125, AE1700, and AE1702 for their ability to enhance separation of sulfate induced precipitation of barium and/or NORM (radium). Each Phillips & Bird PG-700 Series Standard Jar Tester system was filled with 1.4 liters of produced water, which had been previously treated with NaOH and air sparged. Each jar obtained 248 mL of 0.28M Na₂SO₄ and agitated at 150 RPM for 5 minutes. Flocculant was added according to the final concentrations shown in Tables 5, 6, and 7. The mixture was stirred at 300 RPM for 10 seconds, 100 RPM for 2 minutes, 60 RPM for 3 minutes, and then, 20 RPM for 15 minutes. These mixing conditions simulate conventional mixing operations during water treatment, and in particular, a flocculation process, where mixing becomes more gentle as floc forms to avoid breakage of the floc prior to being sent to a clarifier. The samples were then gravitationally separated for 1 minute or 10 minutes, depending upon the sample. Each 2-liter jar was visually inspected and total suspended solids measured using a Hach DR3900 portable instrument. The visual inspection coincided with the total suspended solids measurement and thus, not reported here.

It should be noted that, a skin formed on the surface of the water after flocculant addition, which had a similar color as the floc. This suggests the skin may be a combination of the anionic flocculant and barium sulfate precipitate. This skin was not observed in control samples without flocculant. Furthermore, the skin tended to redisperse during samples and thus, may have influenced estimated total suspended solids.

As can be seen from Tables 5, 6, and 7, the measured total suspended solids (in mg/L) of anionic flocculants AE1125, AE1700, and AE1702, respectively, were substantially lower than the controls, which had high total suspended solids after both 1 minute and 10 minutes of settling. AE1700 and AE1702 had measured total suspended solids lower than that of AE1125 when compared at the lower concentrations of 12.5 mg/L and 25 mg/L. AE1700 was particularly effective at decreasing the total suspended solids measurement at 6.25 mg/L, while AE1702 was more effective at decreasing the total suspended solids measurement at 12.5 mg/L.

TABLE 5
Example 13: Anionic Flocculant AE1125

| Example | Dose, mg/L | TSS (1 minute) | TSS (10 minutes) |
|---|---|---|---|
| 13A | 0 (Control) | High | High |
| 13B | 12.5 | 20 | 22 |
| 13C | 25 | 14 | 7 |
| 13D | 50 | 22 | 18 |
| 13E | 75 | 31 | 34 |
| 13F | 100 | 31 | 31 |

TABLE 6
Example 14: Anionic Flocculant AE1700

| Example | Dose, mg/L | TSS (1 minute) | TSS (10 minutes) |
|---|---|---|---|
| 14A | 0 (Control) | High | High |
| 14B | 6.25 | 6 | 1 |
| 14C | 12.5 | 8 | 12 |
| 14D | 25 | 14 | 18 |
| 14E | 50 | 28 | 26 |
| 14F | 75 | 32 | 31 |
| 14G | 100 | 41 | 36 |

TABLE 7
Example 15: Anionic Flocculant AE1702

| Example | Dose, mg/L | TSS (1 minute) | TSS (10 minutes) |
|---|---|---|---|
| 15A | 0 (Control) | High | High |
| 15B | 6.25 | 4 | 13 |
| 15C | 12.5 | 2 | 2 |
| 15D | 25 | 6 | 6 |
| 15E | 50 | 15 | 14 |
| 15F | 75 | 21 | 18 |

Table 8 shows the analytical results in mg/L, unless stated otherwise, for Examples 13C (25 mg/L AE1125), 14C (12.5 mg/L AE1700), and 15B (6.25 mg/L AE1702). That is, the concentrations of barium, strontium, calcium, magnesium, manganese, iron, sodium, and/or sulfur were determined on untreated feed, as well as the dry solid sludge and treated, filtered clarate. For example, the barium level in the clarate of Example 14C (12.5 mg/L AE1700) and 15B (6.25 mg/L AE1702) was 47 mg/L and 37 mg/L. In contrast, the clarate barium level of Example 13C (25 mg/L AE1125) was 450 mg/L.

TABLE 8

| | | | |
|---|---|---|---|
| | | Example 14C | Example 15B |
| Flocculant, | Example 13C | 12.5 mg/L | 6.25 mg/L |
| GE Betz | 25 mg/L AE1125 | AE1700 | AE1702 |

Untreated, Filtered Produced Water

| | |
|---|---|
| Barium | 4940 ± 10 |
| Strontium | 1375 ± 10 |
| Calcium | 11,300 ± 100 |
| Magnesium | 1020 ± 20 |
| Manganese | 0.3 < x < 0.9 |
| Iron | 8.0 ± 0.3 |

Dry Solid Sludge

| | | | |
|---|---|---|---|
| Barium, wt % | 44.1 ± 0.5 | 43.4 ± 0.5 | 41.5 ± 0.5 |
| Strontium, wt % | 3.23 ± 0.03 | 3.15 ± 0.03 | 3.68 ± 0.03 |
| Calcium, wt % | 2.01 ± 0.05 | 2.34 ± 0.05 | 2.49 ± 0.05 |
| Magnesium, wt % | 1.90 ± 0.02 | 1.59 ± 0.02 | 1.70 ± 0.02 |
| Manganese, mg/L | 100 < x < 300 | 100 < x < 300 | 100 < x < 300 |
| Iron, wt % | 0.38 ± 0.02 | 0.37 ± 0.02 | 0.38 ± 0.02 |
| Sodium, wt % | 1.90 ± 0.02 | 1.04 ± 0.02 | 1.72 ± 0.02 |
| Sulfur, wt % | 12.6 ± 0.2 | 12.7 ± 0.2 | 12.3 ± 0.2 |

Treated, Filtered Clarate

| | | | |
|---|---|---|---|
| Barium | 450 ± 10 | 47 ± 1 | 37 ± 1 |
| Strontium | 925 ± 10 | 945 ± 10 | 870 ± 10 |
| Calcium | 9,600 ± 100 | 9,650 ± 100 | 9,500 ± 100 |
| Magnesium | 815 ± 20 | 820 ± 20 | 830 ± 20 |
| Manganese | <0.3 | <0.3 | <0.3 |
| Iron | <0.3 | <0.3 | <0.3 |

### Examples 16-18

Settling performance was further assessed for flocculants AE1125, AE1700, and AE1702 in a 30-liter vessel. Produced water was spiked with BaCl₂.2H₂O to achieve 6,200 mg barium/liter of produced water. The pH of the barium-spiked produced water was adjusted with a 20 wt % NaOH solution to achieve a pH of 9.0 and aerated for at least 60 minutes to oxidize Fe⁺² to Fe⁺³ and Mn⁺² to Mn⁺⁴. This slurry was treated with 1.064 liter of 1.4M Na₂SO₄ solution to achieve a molar ratio of sulfate to barium of 1.10. Flocculants AE1125, AE1700, and AE1702 were added to the sulfate-treated water to achieve 25 mg/L, 6.25 mg/L and 12.5 mg/L, respectively. The AE1125 containing jar also received coagulant GE-Betz KlarAid™ CDP1336 at 25 mg/L to determine whether the particles that remained from this low molecular weight anionic flocculant during Examples 1 and 12 could be removed. The flocculant-treated water was then stirred with an overhead agitator at 110 RPM for 10 seconds, 45 RPM for 2 minutes, 30 seconds for 3 minutes, and finally 10 RPM for 15 minutes. The agitation protocol was designed to match the protocol utilized with the 2-liter jar examples, as described above, through the use of conventional mixing equations known to one skilled in the art. After agitation, the floc was gravitationally separated. Clarate was pulled from the top of the 30-liter vessel after 1 minute and 10 minutes of settling. The clarate total suspended solids were measured via a Hach DR 3900 Suspended Solids method. Additionally, 1 liter of clarate was drawn for gravimetric suspended solids measurement, which was filtered through a 1 μm glass fiber filter prior to analysis. Treated sludge was drained from the vessel after 15 minutes of settling. The sludge was gravitationally separated for 1-3 days, while clarate was removed periodically until no further clarate formed. The sludge was weighed wet and dried in a vacuum oven at 95° C. to obtain a dry weight. The produced water, treated clarate, and treated sludge were analyzed for barium strontium, calcium, magnesium, manganese, iron, sulfur and sodium through the use of inductively coupled plasmas (ICP) and radium-226 using gamma spectrometry, both in accordance with conventional methodology known by one skilled in the art.

As demonstrated by Table 9, the 10 minutes clarate samples from Examples 16, 17, and 18 had no visible particles present. The samples had visible particles after sitting capped for 4 hours. The gravimetric suspended solids measurements, which were performed 4-24 hours after sampling, reflect the increase in solids. Not to be bound by any particular theory, it is believed that the particulates are due to continued precipitation of sulfates, and in particular barium sulfate.

TABLE 9

| | | TSS, mg/L | | |
|---|---|---|---|---|
| | Anionic Flocculant | Hach DR 3900 | | Gravimetric |
| Example | Treatment | 1′ settling | 10′ settling | 10′ settling |
| 16 | 6.25 mg/L AE1700 | 11 | 21 | Not |
| | | | | Measured |
| 17 | 12.5 mg/L AE1702 | 7 | 7 | 95.5 |
| 18 | 25 mg/L AE1125 + | 70 | 7 | 529 |
| | 25 mg/L KlarAid ™ | | | |
| | CDP1336 | | | |

Examples 16-18 were further analyzed to determine the amount of 226-radium, barium, strontium, calcium, magnesium, manganese, iron, sulfur, and/or sodium present in untreated produced water, dry solid sludge, and treated, filtered clarate. All liquid samples were analyzed by ICP after filtration through a 0.45 μm filter. The untreated produced water was not filtered prior to radium-226 analysis by gamma spectrometry. ICP and gamma spectrometry was performed as discussed above. Dried solid sludge samples were dissolved by acidification, filtered, and analyzed by ICP.

Not to be bound by any theory, it is believed that the variability observed with regard to iron and manganese in the untreated produced water is likely due to variations in the exposure to air prior to treatment; this would result in variations in the extent of iron and manganese oxidation and precipitation prior to any treatments. Furthermore, it is believed that the variability in barium, strontium, calcium, and magnesium in the produced water reflects the reproducibility of the overall produced water preparation, sampling, and analysis processes. Variability in the radium-226 activity for untreated produced water samples is most likely due to variation in the amount of suspended solids among produced water samples.

As can be seen in Table 10, barium concentration and radium-226 activity is substantially decreased in the dry solid sludge and the treated, filtered clarate, as compared to the untreated, filtered produced water for Examples 16, 17, and 18. Measurements are in mg/L unless stated otherwise.

TABLE 10

| | Example 16 | Example 17 | Example 18 |
|---|---|---|---|
| Flocculant, GE Betz | 6.25 mg/L | 12.5 mg/L | 25 mg/L AE1125 + 25 mg/L |
| | AE1700 | AE1702 | KlarAid ™ |
| | | | CDP1336 |

Untreated, Filtered Produced Water

| | | | |
|---|---|---|---|
| Mass, gm | 34300 | 34300 | 34300 |
| ²²⁶Radium, pCi/L | 1272 ± 169 | 2114 ± 246 | 1985 ± 236 |
| Barium | 5470 ± 10 | 6040 ± 10 | 5950 ± 10 |
| Strontium | 1390 ± 10 | 1420 ± 10 | 1340 ± 10 |
| Calcium, wt % | 1.13 ± 0.01 | 1.17 ± 0.01 | 1.18 ± 0.01 |
| Magnesium | 860 ± 20 | 1290 ± 20 | 1330 ± 20 |
| Manganese | <0.3 | 1.8 | <0.3 |
| Iron | <0.3 | 55 | 68 |
| Sulfur as SO₄⁼, mg/L | | 7.2 | |
| Sodium, wt % | 3.81 ± 0.05 | 3.83 ± 0.05 | 3.84 ± 0.05 |

Dry Solid Sludge

| | | | |
|---|---|---|---|
| Mass, gm | 361 | 492.74 | 555.89 |
| ²²⁶Radium pCi/gm | 84 ± 8 | 63 ± 6 | 62 ± 5 |
| Barium, wt % | 42.4 ± 0.5 | 31.6 ± 0.5 | 27.6 ± 0.5 |
| Strontium, wt % | 3.05 ± 0.03 | 2.13 ± 0.03 | 1.71 ± 0.03 |
| Calcium, wt % | 1.45 ± 0.05 | 2.94 ± 0.05 | 2.88 ± 0.05 |
| Magnesium, wt % | 1.97 ± 0.02 | 2.86 ± 0.02 | 1.91 ± 0.02 |
| Manganese | 100 < x < 300 | 100 < x < 300 | 100 < x < 300 |
| Iron, wt % | 0.27 ± 0.02 | 0.29 ± 0.02 | 0.25 ± 0.02 |
| Sodium, wt % | 3.47 ± 0.01 | 8.70 ± 0.01 | 12.07 ± 0.01 |

Treated, Filtered Clarate

| | | | |
|---|---|---|---|
| Volume, liters | 29.68 | 29.57 | 29.51 |
| Mass filtrate, gm | 33899 | 33767 | 33704 |
| ²²⁶Radium pCi/L | 39 ± 4 | 65 ± 5 | 32 ± 8 |
| Barium | 360 ± 10 | 830 ± 10 | 386 ± 10 |
| Strontium | 1005 ± 10 | 1100 ± 10 | 1015 ± 10 |
| Calcium, wt % | 1.13 ± 0.01 | 1.12 ± 0.01 | 1.12 ± 0.01 |
| Magnesium | 920 ± 20 | 705 ± 20 | 820 ± 20 |
| Manganese | <0.3 | <0.3 | <0.3 |
| Iron | <0.3 | <0.3 | <0.3 |
| Sulfur as SO₄⁼, mg/L | | 7.2 | 9.6 |
| Sodium, wt % | 3.90 ± 0.05 | 3.92 ± 0.05 | 3.87 ± 0.05 |

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A method of removing barium and naturally occurring radioactive material from produced water, the method comprising:
pretreating the produced water having a pH in a range of from about 4.0 to about 10.0 by adding a sulfate source to form a suspension of barium sulfate, radium sulfate, or a combination thereof;
treating the pretreated produced water with an anionic flocculant; and
gravitationally separating the treated produced water from the barium sulfate, radium sulfate, or a combination thereof.

2. The method of claim 1, wherein the sulfate source comprises at least one of sodium sulfate, potassium sulfate, magnesium sulfate, calcium sulfate, and strontium sulfate.

3. The method of claim 1, wherein an amount of the sulfate source utilized in pretreating the produced water is based on a molar ratio of sulfate to barium dissolved in the produced water, from about 0.90 to about 1.20.

4. The method of claim 1, wherein the produced water comprises greater than 70,000 mg/L total suspended solids.

5. The method of claim 1, wherein treating the pretreated produced water includes adding a coagulant when the anionic flocculant has a molecular weight below 15 million Daltons.

6. The method of claim 1, wherein treating the produced water includes adding a coagulant when treating the sulfate source and the anionic flocculant alone results in a cloudy clarate greater than 100 mg/L TSS.

7. The method of claim 1, wherein the anionic flocculant includes anionic acrylamide copolymers.

8. The method of claim 1, wherein the anionic flocculant includes copolymers of acrylamide and acrylic acid.

9. The method of claim 1, wherein the anionic flocculant has a molecular weight in a range of about 1 million to about 50 million Daltons.

10. The method of claim 9, wherein the anionic flocculant has a molecular weight in a range of about 15 million to about 50 million Daltons.

11. The method of claim 8, wherein the anionic acrylamide copolymer flocculant has a mole percent in a range of about 50% to about 95%.

12. The method of claim 1, wherein a concentration of the anionic flocculant is in a range of about 1.0 mg/L to about 150 mg/L.

13. The method of claim 1, wherein the anionic flocculant has an anionicity of about 5% to about 30%.

14. The method of claim 1, further comprising adjusting the pH of the produced water, the pretreated water, or the treated water to a range of about 9.0 to about 10.0.

15. The method of claim 14, further comprising adjusting the pH of the produced water to a range of about 9.0 to about 10.0 prior to adding the sulfate source.

16. The method of claim 14, further comprising aerating the pH adjusted water to produce a sludge comprising metal-hydroxides from the produced water.

17. A method of producing a recovered salt product with a low concentration of barium and naturally occurring radioactive materials from produced water, the method comprising:
removing barium and naturally occurring radioactive materials from produced water, comprising:
pretreating the produced water having a pH in a range of from about 4.0 to about 10.0 with a sulfate source to form a suspension of barium sulfate, radium sulfate, or a combination thereof;
treating the pretreated produced water with an anionic flocculant; and
gravitationally separating the treated produced water from the barium sulfate, radium sulfate, or a combination thereof;
evaporating the gravitationally separated water to form distilled water and a concentrated brine;
crystallizing salt crystals from the concentrated brine; and
washing the salt crystals to produce recovered salt product.

18. The method of claim 17, further comprising adjusting the pH of the gravitationally separated water to a neutral pH prior to evaporating the separated water.

19. The method of claim 17, wherein evaporating the separated water is controlled such that the mass concentration factor is maintained between y₁ and y₂, where:
y₁=−0.00001446x+2.046; and
y₂=−2.3591n(x)+25.846,
where x is a feed barium concentration (mg/L).

20. A system for producing a recovered salt product with a low concentration of barium and NORM from produced water, the system comprising:
a barium and NORM treatment apparatus configured to:
pretreat the produced water having a pH in a range of from about 4.0 to about 10.0 with a sulfate source to form a suspension of barium sulfate, radium sulfate, or a combination thereof; and
treat the pretreated produced water with an anionic flocculant;
a gravitational separation unit configured to separate the treated water from the barium sulfate, radium sulfate, or a combination thereof;
an evaporation unit that produces distilled water and a concentrated brine from the separated water;
a crystallization unit configured to produce salt crystals from the concentrated brine; and
a crystal treatment unit configured to wash the salt crystals to produce the recovered salt product.
